(19) United States
(12) Patent Application Publication
(10) Pub. No.: US 2021/0253814 A1
(43) Pub. Date: Aug. 19, 2021

(54) ORGANOSILANE COATING COMPOSITIONS

(71) Applicant: NBD Nanotechnologies, Inc., Brighton, MA (US)

(72) Inventors: Bong June Zhang, Chestnut Hill, MA (US); Esra Altinok, Medford, MA (US); Perry L. Catchings, SR., Roxbury, MA (US)

(21) Appl. No.: 17/099,754

(22) Filed: Nov. 16, 2020

Related U.S. Application Data
(63) Continuation of application No. PCT/US19/32228, filed on May 14, 2019.
(60) Provisional application No. 62/671,138, filed on May 14, 2018.

(51) Int. Cl. C08J 7/04; C08G 77/18; C08G 77/26; C08G 77/20; C08F 220/20; C08F 222/10

(52) U.S. Cl. CPC C08J 7/042; C08G 77/18; C08F 222/102; C08G 77/20; C08F 220/20; C08G 77/26

(57) ABSTRACT

In one aspect, curable coating compositions are provided that comprise (i) one or more organosilanes; and (ii) one or more compounds comprising a substituted acrylate moiety, a substituted acrylamide moiety or a substituted vinyl ether moiety. The compositions can produce a strong outer coating layer on a variety of substrate surfaces.

The present application is a continuation of International Application No. PCT/US2019/032228, filed May 14, 2019, which claims the benefit of priority of U.S. provisional application No: 62/671,138, filed on May 14, 2018, both of which application are incorporated herein by reference in their entirety.

### FIELD

The present invention relates to organosilane compositions. Preferred compositions can provide a strong outer coating layers for a variety of substrate surfaces.

### BACKGROUND

Substrates having treated surface layers are used in various fields. For example, in the transportation industry, such as automobiles, ships, aircrafts, and the like, surfaces of an exterior parts, such as outer panels, window glass, rear view camera lens, or mirror glass, or interior parts, such as a display surface material, an instrument panel, or other articles, are desired to be easily cleaned and to maintain their surface integrity. In the electronics industry, treated surfaces are used in mobile phones, electronic device displays, and the like. And in the building construction and home design industries, treated surfaces are used on windows, doors, decorative panels, furniture, and appliances, such as refrigerators, ovens, ranges, and the like. In the retail segment, treated surfaces are found in athletic wear, shoes and the like.

In particular, electronic devices often are treated with protective coatings to reduce scratch and other abrasion damage. For instance, displays used on mobile devices such as phones and tablets generally include glass or plastic lens elements. Certain coating systems have been reported to treat such lens elements to reduce abrasion damage. See US2016/0085370.

It would be desirable to have new coating systems.

### SUMMARY

We now provide new organosilane compositions. Preferred compositions can be used as coating layers on a wide variety of substrates, including as permanent surface coatings. Particularly preferred compositions can exhibit notable hardness as well as substantial flexibility.

For many applications, we recognized the need for a permanent coating layer that is both hard and flexible.

We have now surprising found that preferred compositions disclosed herein can provide cured coating layers that exhibit both significant hardness and flexibility. See, for instance, the results set forth in the Examples which follow.

More particularly, preferred coating compositions comprise (i) one or more organosilanes and (ii) one or more compounds comprising a substituted acrylate moiety, a substituted acrylamide moiety or a substituted vinyl ether moiety.

Particularly preferred organosilanes include polymeric materials that comprise siloxane repeat units, including repeat units that comprise multiple Si atoms, such as bis- and tris-units of the following Formulae (I) and (II):

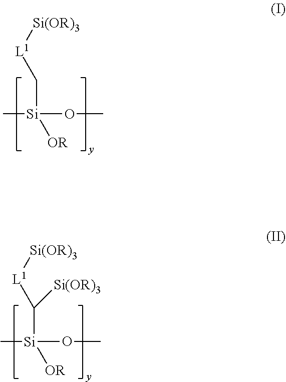

wherein in each of those Formulae (I) and (II), L¹ is a linker such as a chemical bond, optionally substituted alkylene e.g. (—CH₂—)₁₋₈; or optionally substituted heteroalkylene e.g. —(CH₂W)₁₋₈ where W is N, O or S; each R is independently a hydrogen or non-hydrogen substituent such as optionally substituted alkyl; and y is a positive integer.

In a preferred aspect, siloxanes are provided that comprise a carbamate group. Compositions including curable composition also are provided that comprise one more such siloxanes that comprise carbamate functionality.

In a preferred aspect, siloxanes are provided that comprise a urea group. Compositions including curable composition also are provided that comprise one more such siloxanes that comprise urea functionality.

In a further preferred aspect, organosilanes or siloxanes are provided that comprise both carbamate and urea groups. In this aspect, the weight ratio of carbamate groups to urea groups in a siloxane can vary, for example from 1:99 to 99:1 weight ratio of carbamate groups:urea groups, or a weight ratio of 20:80 to 80:20 carbamate groups:urea groups. In certain aspects, preferred siloxanes will comprise both carbamate and urea groups with the urea groups in a greater weight ratio relative to the carbamate groups, for example the urea groups will be present in at a weight ratio of 51, 60, 70, 75 or 80 weight percent or more based on total weight of the urea and carbamate groups present in siloxanes.

Preferred organosilanes for use in the present compositions also include higher order polymeric materials that comprise 2, 3, 4, 5 or more distinct repeat units, i.e. copolymers, terpolymers, tetrapolymers, pentapolymers and other higher order materials.

In a particular aspect, organosilanes that comprise one or more carbamate moieties are preferred, such as organosilanes that comprise a unit of the following Formula (III):

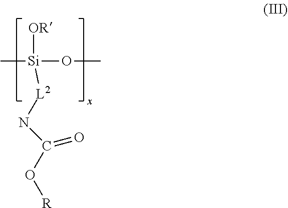

wherein in Formula (III) L² is a linker such as a chemical bond or optionally substituted alkylene e.g. (—CH₂—)₁₋₈; R and R¹ are the same or different and may be hydrogen or a non-hydrogen substituent such as optionally substituted alkyl; and x is a positive integer.

In a further particular aspect, organosilanes that comprise one or more urea moieties are preferred, such as organosilanes that comprise a unit of a Formula (IIIC), wherein Formula (IIIC) is the same as defined above form Formula (III) expect a urea moiety is in place of the depicted carbamate moiety. Thus, in particular, in Formula (IIIC), the linkage —Si-L²-N—C(═O)—N—R may be provided.

As discussed, in addition to an organosilane, the present compositions comprise one or more compounds that comprise a substituted acrylate moiety, a substituted acrylamide moiety and/or a substituted vinyl ether moiety. Compounds that comprise one or more hydroxy acrylate groups are generally preferred.

In particularly preferred aspects, the present composition can be applied on a substrate as a fluid coating without use of a separate casting solvent. Thus, for example, the organosilane component may be dissolved or dispersed together with the component that comprises one or more substituted acrylate, acrylamide or vinyl ether groups. The fluid composition can applied by any suitable means, e.g. dip, spin or spray coated, onto a substrate followed by curing without need for a separate step of solvent removal.

In certain preferred embodiments, the one or more organosilanes do not include fluorine substitution. In particular aspects, the coating composition is at least substantially free of fluorine, i.e. less than 3, 2, 1 or 0.5 weight percent fluorine based on total composition weight.

In certain aspects, the one or more organosilanes of a coating composition may comprise a polyhedral oligomeric silsesquioxane (POSS) moiety. In other aspects, the one or more organosilanes do not include any POSS moieties.

In particular aspects, the present coating compositions may include one or more additional materials, such as one or more antimicrobial agents that can provide an applied composition coating layer that is substantially microbe-free or microbe-resistant. Additional preferred additives include one or more colorants or fluorescent agents that can provide desired visible characteristics to an applied layer of the coating compositions.

The present compositions may be used advantageously on a wide range of substrates such as glass, plastics, wood, cellulosic products, metal surfaces such as aluminum, steel, brass, and surfaces with various types of applied coatings including paints. The coating system is especially applicable to various polymeric substrates such as polycarbonate, polystyrene, polyester. The substrates may be for example a display including for a mobile device.

In certain aspects, a composition layer will be the outermost surface layer on a substrate. That is, in such aspects, additional layers are not coated over a layer of a present coating composition.

In particular aspects, an applied composition coating layer, including following curing, will be substantially transparent, for example the coating layer will transmit 60, 70, 80, 90% or more of incident visible light.

As discussed, preferred hardened or cured coating layers of the present compositions can exhibit significant hardness such as at least 4H, 5H or 6H on a cPI (polyimide) film substrate and/or at least 7H, 8H or 9H on a glass substrate. Hardness values as referred to herein may be determined using the ASTM D3363 Standard test method as exemplified in Example 6 which follows. Such hardness values are preferably provided with relatively thin composition coating layers, for example cured composition coating layers having a thickness of 50-400 nm or 100-300 nm.

Preferred hardened or cured coating layers of the present compositions also can exhibit significant flexibility. For instance, preferred cured composition layers (including cured composition coating layers having a thickness of <1 μm) will exhibit either no detected or no notable or significant delamination or cracking by a Static Bending Test as exemplified in Example 5 which follows. As referred to herein, no notable or significant degradation or cracking indicates no intended performance of the coating layer is compromised.

That Static Bending Test as referred to herein includes: 1) folding a cured composition coating layer (the composition coated on a foldable substrate such as the polyimide of Example 5 which follows, the cured composition layer having a thickness of <1 μm) at 180°; 2) storing such folded samples at 70° C. and −40° C. for at least 3 days; and 3) after such storage periods, examining the coating layers visually and with a microscope for degradation such as delamination or cracking.

Methods are also provided for providing a coating composition layer. Substrates such as a mobile device or a display element are further provided having coated thereon a composition of the invention.

Other aspects of the invention are discussed infra.

### BRIEF DESCRIPTION OF DRAWING

FIGS. 1A-1B show ASTM D3359 standard test methods for rating adhesion by tape test cross cut with 1 mm² grid (FIG. 1A) and 50 times magnification (FIG. 1B).

FIGS. 2A-2B show static bending test results.

FIG. 3 shows a schematic test setup for pencil hardness. Inset shows chip and nick free edge of lead.

FIG. 4 shows a schematic pencil hardness test result of the specimen coated on glass.

### DETAILED DESCRIPTION

### Organosilanes

As discussed, preferred organosilanes include polymeric materials that comprise siloxane repeat units, including repeat units that comprise multiple Si atoms. Bis- and tris-units of the following Formulae (I) and (II) are particularly suitable:

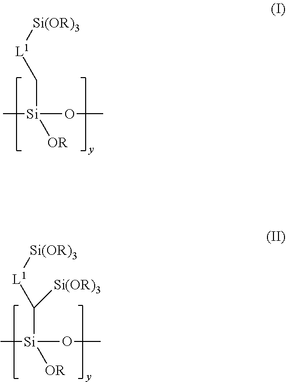

wherein in each of those Formulae (I) and (II):

each R is independently a hydrogen or non-hydrogen substituent such as optionally substituted alkyl e.g. optionally substituted C₁-C₁₂, C₁-C₈, C₁-C₄ or C₁-C₂ alkyl;

L¹ is a linker group such as a chemical bond, optionally substituted alkylene, e.g, optionally substituted C₁-C₁₂, C₁-C₈, C₁-C₄ or C₁-C₂ alkylene, or optionaly substituted heteroalkylene, e.g., 2-10 membered, 2-8 membered, 2-4 membered or 2-3 membered heteroalkylene; and

y is a positive integer.

As also discussed, preferred organosilanes may include carbamate substitution. In a0 particular aspect, orangosilanes are provided that comprise one or more units of the following Formula (III):

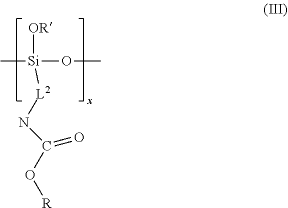

wherein in Formula (III):

each R and R¹ are the same or different and may be a hydrogen or non-hydrogen substituent such as optionally substituted alkyl e.g. optionally substituted C₁-C₁₂, C₁-C₈, C₁-C₄-C₄ or C₁-C₂ alkyl;

L² is a linker group such as a chemical bond, optionally substituted alkylene, e.g, optionally substituted C₁-C₁₂, C₁-C₈, C₁-C₄ or C₁-C₂ alkylene, or optionaly substituted heteroalkylene, e.g., 2-10 membered, 2-8 membered, 2-4 membered or 2-3 membered heteroalkylene; and

x is a positive integer.

Particularly preferred are organosilanes that comprise one or more units of the above Formulae (I) and/or (II) and further include carbamate substitution and/or comprise urea substitution. For instance, in preferred aspect, organosilanes may comprise a structure of either the following Formulae (IIIA) or (IIIB):

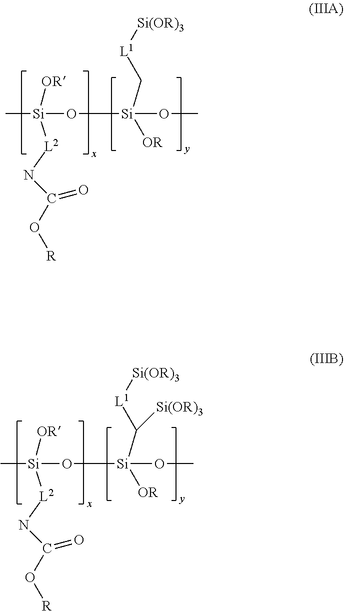

wherein in Formulae (IIIA) and (IIIB), L1, L² R, R′, x and y are the same as defined in Formulae I, II and III above.

In a further preferred aspect, organosilanes may comprise a structure of either Formulae (IIID) or (IIIE), which Formulae (IIID) or (IIIE) are the same as defined for Formulae (IIIA) and (IIIB) respectively, except a urea moiety is provided in place of the depicted carbamate moiety.

Suitable organosilanes are commercially available or can be readily prepared. For instance, one or more silanols or silyl ethers can be reacted to provide a suitable organosilane. Preferred polymeric materials such as those of Formulae (IIIA) and (IIIB) may be readily synthesized in accordance with the following Scheme 1:

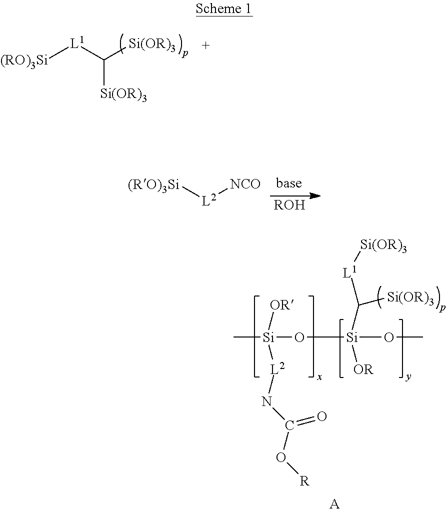

As depicted in Scheme 1, a bis- or tris-silanol or silylether is reacted with a isocyano-silanol or silyl ether reagent under basic conditions to provide the depicted copolymer A. In that Scheme 1, each R and R′ are independently hydrogen or a non-hydrogen substituent such as optionally substituted alkyl e.g, optionally substituted C₁-C₁₂, C₁-C₈, C₁-C₄ or C₁-C₂ alkyl. L¹ and L² are the same or different linker groups such as a chemical bond, optionally substituted alkylene, e.g, optionally substituted C₁-C₁₂, C₁-C₈, C₁-C₄ or C₁-C₂ alkylene, or optionally substituted heteroalkylene, e.g., 2-10 membered, 2-8 membered, 2-4 membered or 2-3 membered heroealkylene; x and y are the same or different positive integers, for example x and y each suitably may be 1 to 100; and p is 0 (to provide a bis-compound such as a group of Formula (I) above) or 1 (to provide a tri-compound such as a group of Formula (II) above).

Preferably, each R and R′ are each independently hydrogen, or unsubstituted C₁-C₄ alkyl, e.g, methyl and ethyl. Preferably, L¹ and L² are independently each a bond, unsubstituted C₁-C₄ alkylene, e.g., methylene or etheylene.

The above scheme and synthesis also can provide an organosilane or siloxane that comprises urea groups. The above scheme and synthesis also can provide an organosilane or siloxane that comprises a mixture of carbamate and urea groups, including where the urea groups are present in a weight excess relative to the carbamate groups present. Such material (organosilane or siloxane) may be used in a composition with a mixture of urea and carbamate groups.

Organosilanes used in the present coating composition may suitably vary widely in molecular weight and polydispersity. Suitable organosilanes include those that have a M_{w} of from about 300 to about 10,000, more typically about 300 to about 20,000 with a molecular weight distribution of about 3 or less, more typically a molecular weight distribution of about 2 or less.

References herein to “acrylate” groups or compounds is inclusive of where the acrylate vinyl group is substituted by an optionally substituted C₁₋₈ alkyl or other group. Thus, the term acrylate includes methacrylates.

The term “alkylene,” by itself or as part of another substituent, means, unless otherwise stated, a divalent radical derived from an alkyl, as exemplified, but not limited by, —CH₂CH₂CH₂CH₂—. Typically, an alkyl (or alkylene) group will have from 1 to 24 carbon atoms, or more typically 1-12, 1-8 or 1-4 carbon atoms.

The term “heteroalkylene,” by itself or as part of another substituent, means, unless otherwise stated, a divalent radical derived from heteroalkyl, as exemplified, but not limited by, —CH₂—CH₂—O—CH₂—CH₂— and —CH₂—O—CH₂—CH₂—NH—CH₂—. For heteroalkylene groups, heteroatoms (N,O, S) can also occupy either or both of the chain termini (e.g., alkyleneoxy, alkylenedioxy, alkyleneamino, alkylenediamino, and the like).

A carbamate group may comprise the moiety —N(R)—C(═O)—O— where R is hydrogen or a non-hydrogen substituent. A urea group may comprise the moiety —N(R)—C(═O)—N(R′)— where R and R′ are the same or different and may be hydrogen or non-hydrogen substituent.

As discussed herein, various materials and substituents (including groups of Formulae (I), (II), (III), (IIIA) and (IIIB) which may be “optionally substituted” may be suitably substituted at one or more available positions by e.g. halogen (F, Cl, Br, I); cyano; nitro; hydroxy; amino; alkyl such as C₁₋₂₀ alkyl or C₁₋₈ alkyl; alkenyl such as C₂₋₈ alkenyl; alkylamino such as C₁₋₂₀ alkylamino or C₁₋₈ alkylamino; thioalkyl such as C₁₋₂₀ athioalkyl or C₁₋₈ thioalkyl; carbocyclic aryl such as phenyl, naphthyl, benzyl, etc; and the like.

### Coating Compositions

As discussed above, the one or more organosilanes are used in combination with one or more distinct compounds that comprise a substituted acrylate moiety, a substituted acrylamide moiety or a substituted vinyl ether moiety.

In certain aspects, preferred components that comprise a substituted acrylate, acrylamide or vinyl ether moiety may be non-polymeric (no repeat units) and/or have a molecular weight of less than 1500, or less than 1000, 800, 700, 600 500 or 400. In the other aspects, a polymeric material may be suitable.

Specific components that comprise a substituted acrylate, acrylamide or vinyl ether moiety include for example 2-hydroxyethyl methacrylate: hydroxymethyl methacrylate, hydroxypropyl methacrylate, 2-aminoethyl methacrylate, glycidyl methacrylate, poly(ethylene glycol)methacrylate, 2-isocyanatoethyl methacrylate; N-hydroxyethyl acrylamide; N-(2-hydroxyethyl) methacrylamide; N-(hydroxymethyl)methacrylamide; N-(hydroxymethyl)acrylamide; 2-aminoethylmethacrylamide; 4-hydroxybutyl vinyl ether. In certain aspects, hydroxy acrylates (includes hydroxyl methacrylate sand other hydroxyl alkylacrylates) are preferred.

A further preferred composition component that comprises a substituted acrylate, acrylamide or vinyl ether moiety includes compounds that comprise multiple acrylate groups (a multi-acrylate compound) such as diacrylate and triacrylate compounds for example 1,6-hexanediol diacrylate, 1,6-hexanediol dimethacrylate: 1,3-butanediaol diacrylate, 1,4-butanediol diacrylate, 1,6-hexanediol diacrylate, poly(ethylene glycol) diacrylate, glycerol 1,3-diglycerolate diacrylate, and bisphenol A ethoxylate diacrylate.

A preferred acrylate material that may contain multiple acrylate groups for use in the present compositions is dipentaerythritol penta-/hexa-acrylate acrylate (DPPHA or DPHA)

In particular aspects, multiple distinct compounds that comprise a substituted acrylate, acrylamide or vinyl ether moiety are used in combination. For example, in certain aspects, a multi-acrylate compound is used in combination with one or more other distinct compounds such as one or more compounds that comprise a single substituted acrylate, acrylamide or vinyl ether moiety. For certain aspects, preferred is use of a multi-acrylate compound together with a distinct compound that comprise a single acrylate group such as a hydroxyl acrylate compound.

The additional composition component that comprises a substituted acrylate, acrylamide or vinyl ether group can suitably react to harden an applied coating composition layer. In preferred aspects, the additional component will react to form covalent bonds (crosslink) with composition components which may include the one or more organosilanes.

Such hardening of an applied coating composition suitably may occur with thermal treatment or exposure to activating radiation. The coating composition may include a curing agent to promote the hardening reaction, for example a thermal curing agent that may generate an active agent at elevated temperatures, or a photoinitiator compound that promotes curing agent upon exposure to activating radiation. In certain aspects, use of a photoinitiator compound is preferred together with blanket exposure to ultraviolet or other activating radiation at room or elevated temperature.

A variety of thermal and radiation-sensitive curing agents may be employed. Suitable photoinitiators include organic agents such as for example 2-hydroxy-2-methylpropiophenone: lrgacure™, Drocur™, 4,4′-Bis(diethylamino)benzophenone, Benzopheone, 2-chlorothioxantheri-9-one, 2-hydroxy-2-methylpropiophenone, 3-hydroxybenzophenone, and 4′-ethoxyacetophenone.

The present coating compositions also may contain other materials. For example, other optional additives include nanoparticles such as SiO₂, TiO₂, Al₂O₃, Al(OH)₃, ZnO, Sb₂O₃, Fe₂O₃, CeO₂, etc. Such optional additives typically will be present in minor concentration in a composition.

Preferred additional coating compositions agents include antimicrobial agents that can provide a coating layer that is substantially free of bacteria or other microbes. Antimicrobial agents can be both inorganic and organic materials. See the examples which follow for preferred agents and amounts for use in a coating composition.

Preferred additional coating compositions agents include microbe-and/or one or more colorants or fluorescent agents to provide desired visible characteristics to an applied layer of the coating compositions. Colorants also may be organic or inorganic materials. See the examples which follow for illustrative colorant agents.

Composition components suitably may be present in varying amounts. For instance, the weight ratio 1) the one or more organosilanes the 2) one or more compounds that comprise one or more substituted acrylate, acrylamide or vinyl ether moieties suitably may be 1:10 to 10:1, more typically, a weight ratio of 2:8 to 8:2 or 3:7 to 7:3. In certain aspects, a weight ratio of 1) the one or more organosilanes the 2) one or more compounds that comprise one or more substituted acrylate, acrylamide or vinyl ether moieties suitably may be 4:6 to 6:4.

A curing agent if employed typically will be present in relatively minor amounts such as less than 10, 5, 4, 3, 2 or 1 weight percent of the total composition weight.

A multi-acrylate compound if employed typically will be present in relatively minor amounts such as less than 10, 5, 4, 3, 2, or 1 weight percent of the total composition weight. As discussed, preferred compositions do not include an additional solvent component, rather reactive composition components are dissolved or dispersed together to provide a fluid solution or mixture. If desired, however, one or more carrier solvents may be utilized to impart desired viscosity and other characteristics to the composition. One or more organic solvents are generally preferred such as for example glycol ethers such as 2-methoxyethyl ether (diglyme), ethylene glycol monomethyl ether, and propylene glycol monomethyl ether; propylene glycol monomethyl ether acetate; lactates ethyl lactate; propionates such as ethyl ethoxy propionate and methyl-2-hydroxy isobutyrate; and ketones such as methylethyl ketone and 2-heptanone. A blend of solvents such as a blend of two, three or more of the solvents described above may be suitable. If utilized, a solvent component may be suitably present in the composition in an amount of from 50 to 90 or 95 wt % based on the total composition weight

The present compositions are generally prepared by admixing the composition components followed by agitation such as mechanical stirring or ultrasonication to provide a substantially uniform fluid composition. A composition may be applied to a substrate by any suitable method, including spin coating, spray coating or dip coating.

Following applying a composition coating layer on a substrate, the layer is hardened as discussed typically either by thermal treatment of exposure to ultraviolet or other activating radiation. In one aspect, the coating later is blanket exposed to ultraviolet radiation for 0.5 to 10 minutes or until the coating layer is hardened as desired. Radiation curing may be at room temperature or elevated temperature such as 30 to 80° C. or more as may be desired to effectively harden a specific composition.

### Surfaces and Applications

There is no particular restriction as to the substrate to which the present compositions may be applied, For example, substrates include leather, metal, plastic, glass, ceramic or other inorganic materials, organic materials, or a combination thereof, such as composite materials, laminated materials, and the like. Further, the surface of the substrate may be the substrate surface itself, or may be the surface of a material different from the substrate surface, such as the coating surface of a coated metal plate, or the surface of a surface-treated layer of surface-treated glass. With respect to the shape of the substrate, it may not necessarily be a flat plate, and it may have an optional shape depending upon the particular purpose, such as the one having a curvature over the entire surface or at a part thereof, such as in a mobile phone screen having rounded edges for a full edge-to-edge screen.

For the surface treatment of the substrate, no special pretreatment is required. However, pretreatment may be conducted as the case requires. For example, acid treatment with e.g. diluted hydrofluoric acid or hydrochloric acid, alkali treatment with e.g. an aqueous sodium hydroxide solution, or discharge treatment by e.g. plasma irradiation, may be conducted.

In the present invention, a particularly suitable substrate is a substrate made of a transparent material such as leather, glass or plastic, and a suitable article having such a substrate mounted to utilize the transparency. Thus, the substrate of the present invention is particularly suitable for articles for transportation equipment and articles for buildings or building decorations.

Articles for transportation include, but are not limited to, exterior parts such as outer plates, window glass, mirrors and display panels, and interior parts such as instrument panels of cars, buses, trucks, automobiles, ships or aircraft. Such an article may be composed solely of the surface-treated substrate or may have the surface-treated substrate incorporated therein. For example, the former may be a window glass for an automobile, such as a windshield, and the latter may be a side mirror for an automobile in which a glass mirror is incorporated into a housing unit mounted on the exterior of the automobile.

The articles for use in transportation include vehicle bodies, window glass, such as windshield, side windows, rear window, and sunroof, mirrors, and leather upholsteries, such as seat, covers, padding, and the like for use in automobiles, buses or trucks, ships, and aircraft.

Further, articles for buildings or building decorations may be articles to be attached to buildings or articles already attached to buildings, or articles for buildings which are not attached to buildings but which are used in buildings, articles for buildings include, but are not limited to, furniture or equipment, and base materials, such as glass plates.

Specifically, they include window glass plates, window glass, glass plates for roofs, glass plates for doors or doors having such glass plates installed, glass plates for partitions, glass plates for green houses, or green houses having such glass plates, transparent plastic plates to be used instead of glass, the above-mentioned various articles for buildings (window materials and roof materials) having such plastic plates incorporated, wall materials made of ceramics, cement, metals or other materials, mirrors, furniture and display shelves having such walls or mirrors, and glass for showcases.

Such an article may be made of the surface treated substrate alone or may be the one having the surface treated substrate incorporated therein. For example, the former may be a window glass plate, and the latter may be furniture in which a glass mirror is incorporated.

The following examples are illustrative of the invention.

### EXAMPLE 1

### Synthesis of Bis-CoPolymer

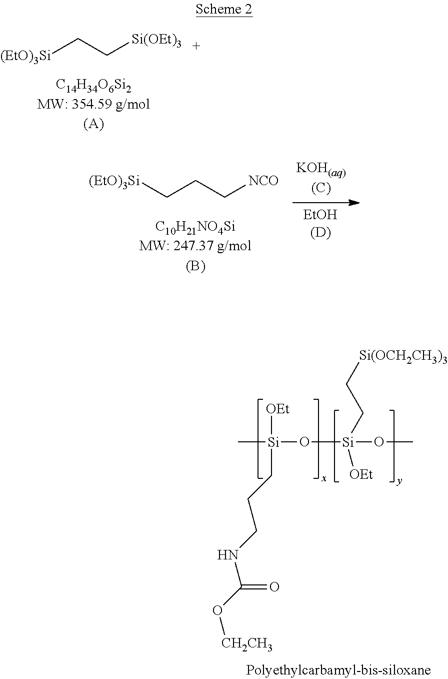

### Material

A: 1,2-bis(triethoxysilyl)ethane (Gelest SIB 1817.0, CAS: 16068-37-4); B: 3-isocyanatopropyl triethoxysilane (Gelest SII 6455.00, CAS: 24801-88-5); C: potassium hydroxide (Sigma Aldrich P1767, CAS: 1310-58-3) in DI Water; D: ethanol (Alfa Aesar 33361, 94-96%, CAS: 64-17-5; E: dichlormethane (Alfa Aesar 22917, CAS: 75-09-2)

### Procedure

As generally depicted in the above Scheme 2, in a 100 mL single neck RBF equipped with a stir bar, an amount of 10.16 g (0.041 moles) of 3-isocyanatopropyl triethoxysilane (B), an amount of 1.04 g (2.93 mmoles) of 1,2-Bis(triethoxysilyl)ethane (A), and 20 mL of Ethanol (D) were charged and the reaction mixture was stirred for 10 min. 2 mL of aqueous KOH (C) (10 mg/mL) was charged into the reaction mixture dropwise and the reaction was stirred at ambient temperature for 15 hours. Then, the reaction mixture was transferred to a 100 mL separatory funnel and 20 mL of dichloromethane was charged. Water was added to the reaction and washed twice. Organic phase was separated and dried using sodium sulfate. The solvent was removed in vacuo and an amount of 9.5 g of a waxy solid product was obtained.

### EXAMPLE 2

### Synthesis of Tris-CoPolymer

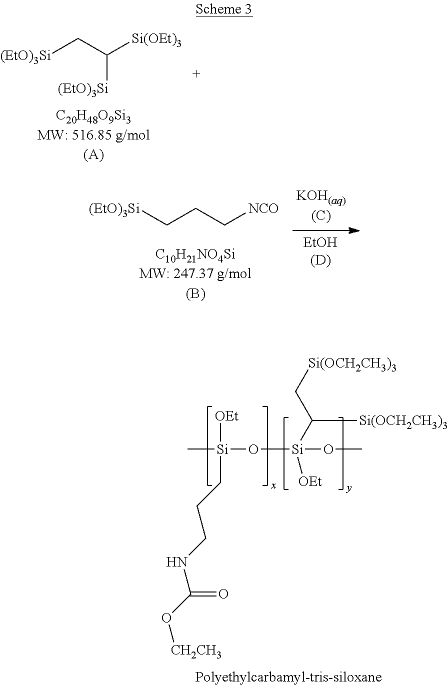

### Material

A: 1,1,2-Tris(triethoxysilyl)ethane (Gelest SIT8716.6, CAS: 151198-82-2); B: 3-isocyanatopropyl triethoxysilane (Gelest SII 6455.00, CAS: 24801-88-5); C: potassium hydroxide (Sigma Aldrich P1767, CAS: 1310-58-3) in DI Water; D: ethanol (Alfa Aesar 33361, 94-96%, CAS: 64-17-5; E: dichlormethane (Alfa Aesar 22917, CAS: 75-09-2)

### Procedure

As generally depicted in the above Scheme 3, in a 1 L single neck RBF equipped with a stir bar and dropping funnel, an amount of 195 g (0.788 moles) of 3-isocyanatopropyl triethoxysilane (B), an amount of 19.4 g (0.0375 moles) of 1,1,2-tris(triethoxysilyl)ethane (A), and 310 mL of ethanol (D)were charged and the reaction mixture was stirred for 15 min. 38 mL of aqueous KOH (C) (10 mg/mL) was charged into the reaction mixture dropwise and the reaction was stirred at ambient temperature for 15 hours. Then, a half of the reaction mixture was transferred to a 500 mL separatory funnel and 200 mL of dichloromethane was charged. The reaction was washed twice with water. Organic phase was separated and dried using sodium sulfate. The solvent was removed in vacuo. The other half of the reaction mixture was washed and separated likewise. 207 g of a waxy solid product was obtained. The polyethylcarbamyl-bis-siloxane product provided the following NMR spectra and elemental analyses:

¹H NMR (CDCl3, 500 MHz): § 0.54-0.57 (m), 0.59 (m), 1.12-1.16 (m), 1.49-1.54 (m), 3.06-3.09 (m), 3.71-3.76 (m), 4.85 b(s, br). ¹³C NIVIR (CDCl₃, 125.7 MHz): § 1.43, 7.52, 1456, 18.15, 18.20, 18.29, 23.61, 42.82, 58.24, 58.31, 58.35, 158.42. ²⁹Si NMR (CDCl₃, 99.3 MHz) § -45.42. Calcd for C₁₈H₄₁NO₉Si₃: C, 43.08; H, 8.64; N, 2.79. Found: C, 47.06; H, 9.28; N, 5.57. Mn [g/mol]: 582, Mw [g/mol]: 1095.

### EXAMPLE 3

### Preparation and use of a Coating Composition

A coating composition was prepared containing the following materials in the specified amounts:

1. Siloxane of tri-copolymer of Example 2: 0.4 grams

2. 2-hydroxyethylmethacrylate: 0.5 grams

3. 2-hydroxy-2-methylpropiophenone: 0.05 grams

4. 1,6-hexanediol diacrylate: 0.05 grams

These materials were admixed in a vial and ultrasonicated for 10 minutes. The composition is considered solvent free because individual components are miscible with each other without assistance of a further solvent. The composition was air-sprayed at 30 psi to cPI (co-polymerized imide, KOLON CPI™) films without dilution. The applied composition coating layer was UV-cured for 2 minutes (400 Watts).

### EXAMPLE 4

### Adhesion Testing

Adhesion of the cured coating composition of Example 4 above was assessed by ASTM D3359 “Standard test methods for rating adhesion by tape test”.

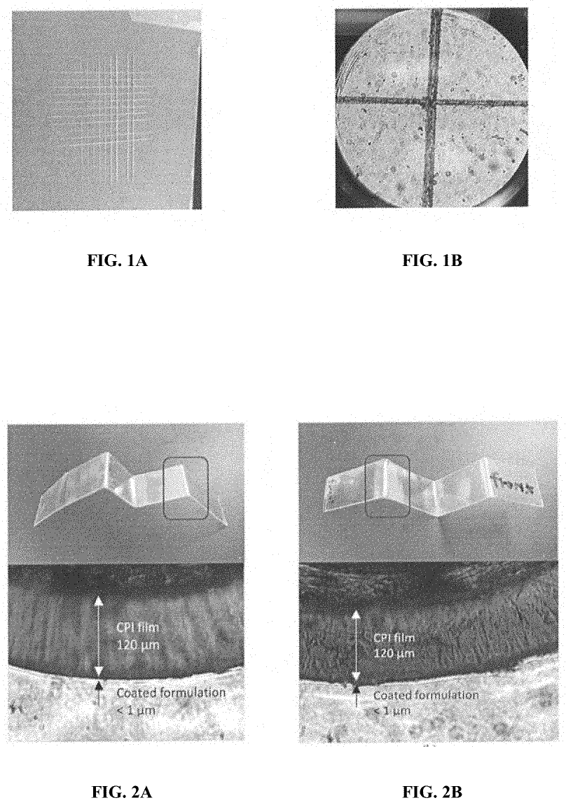

The coated composition layer was immersed in hot water (80° C.) for 30 minutes and taken out of water. The surface was gently wiped with Kimwipes to remove water. Using sharp serrated razor blades with 1 mm width, incisions were made vertically to intersect each other (FIG. 1A). 20 mm wide semitransparent pressure sensitive tape was applied on the incision area. Tape was removed from the surface. The surface was inspected visually and assessed based upon the classification of adhesion test results (see Table 1).

As shown in FIGS. 1A-1B, no marginal delamination or defect was observed along the cuts. Adhesion of the coating layer was classified as 5B (0% or none of failure, see table 1). Even after microscopic examination (50 times magnification), no microscopic failure or defect along the cuts was confirmed.

In general, ISO or ASTM categorizes the coating failure into 5 classes (0 to 5). The film was rated as 0 out of 5 or ASTM class 5B, which means no of failure observed during cross cut.

TABLE 1
Classification of adhesion test results
Classification of adhesion test results

| Classification | 5B | 4B | 3B | 2B | 1B | 0B |
|---|---|---|---|---|---|---|
| Percent area | 0% | 5%> | 5-15% | 15-35% | 35-65% | 65%< |
| removed | None | | | | | |

### EXAMPLE 5

### Static Bending Test

A cured composition coating layer was prepared on a CPI (polyimide) substrate as described in Example 3 above.

The coated specimens were folded at 180° (i.e. folded in half) multiple times. The diameter of the specimen was measured using calipers. The diameter was approximately 1 mm. Each specimen was stored at different conditions at a temperature of 70° C. for 10 days and at a temperature of −40° C. for 3 days, respectively.

After test, the surfaces of each specimen were examined visually and microscopically. Insets of FIGS. 2A-2B show that cross-sectional views of interlayers of CPI film and coating. Thicknesses of the CPI film substrate and the cured composition coating layer were 120 μm and <1 μm, respectively. No specific delamination or cracking was observed at the boundary of two films.

### EXAMPLE 6

### Pencil Hardness Test (ASTM D3363)

Hardness of a cured composition coating layer was assessed by using ASTM D3363 Standard test method.

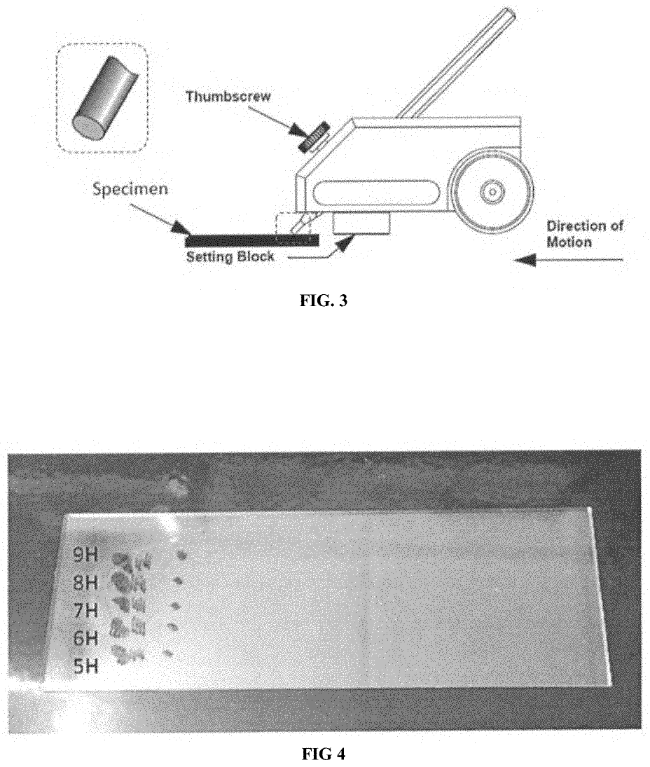

Prior to the test, the pencil was sharpened by the special pencil sharpener supplied from BYK. The hardness of pencils was varied from 6B (soft) to 8H (hard). The lead was sharpened until approximately 5 mm to 6 mm. The lead was rubbed to the abrasive paper (400 grit) at a temperature of 90° C. until a flat, smooth, and circular cross-section was achieved. The pencil tester was set as shown in FIG. 3. When the specimen was placed under the tip of pencil, the push force was applied. The speed of the pencil tester was between 0.5 mm/s to 1 mm/s. The surface of the specimen was inspected visually to check scratches or gouges.

The specimen prepared by aforementioned formulation (Tris-carbamate POSS: hydroxyethyl methacrylate: photo-initiator: diacrylate=0.4 g:0.5 g:0.05 g:0.05 g) was confirmed 6H hardness. In order to improve the hardness, the formulation was modified as shown below:

By the procedures described in Example 3 above, a coating composition was prepared containing the following materials in the specified amounts:

1. Siloxane of tri-copolymer of Example 2:0.6 grams

2. 2-hydroxyethylmethacrylate: 0.7 grams

3. 2-hydroxy-2-methylpropiophenone: 0.01 grams

4. 1,6-hexanediol diacrylate: 0.01 grams

The pencil hardness test was carried out as described above. As shown in FIG. 4, the hardness was checked from 5H to 9H. No gouges or scratches was seen on the glass specimen coated with aforementioned formulation. The hardness of the specimen was confirmed 9H or more.

### EXAMPLES 7-10

### Antimicrobial Compositions and Testing

### Example 7

### Antimicrobial Composition

A coating composition was prepared containing the following materials as follows:
1) Siloxane of bis-copolymer of Example 1
2) 2-hydroxyethylmethacrylate
3) Dipentaerythritol penta-/hexa-acrylate
4) 1,6-hexanediol diacrylate
5) Omnirad 184 photointiator (IGM)
6) Polyether-modified silicone-based surface agent (BYK-307, BYK Chemie)

These six components were admixed at a relative weight percent of 30:20:20:16:3:1. To that mixture, AEM5772 (Micrboan) antimicrobial additive was added in an amount of 0.5 weight percent based on weight of the admixture. These materials were ultrasonicated for about 10 minutes. The composition is considered solvent free because individual components are miscible with each other without assistance of a further solvent.

The composition was air-sprayed onto a polycarbonate phone cases using an air spray gun. The coated phone case was UV-cured.

### Example 8

### Additional Antimicrobial Composition

A coating composition was prepared containing the following materials as follows:
1) Siloxane of bis-copolymer of Example 1
2) 2-hydroxyethylmethacrylate
3) 1,6-hexanediol diacrylate
4) Omnirad 184 photointiator (IGM)
5) Polyether-modified silicone-based surface agent (BYK-307, BYK Chemie)

These five components were admixed at a relative weight percent of 35:45:9:10:1. To that mixture, AEM5772 (Micrboan) antimicrobial additive was added in an amount of 0.5 weight percent based on weight of the admixture. These materials were ultrasonicated for about 10 minutes. The composition is considered solvent free because individual components are miscible with each other without assistance of a further solvent.

The composition was air-sprayed onto a polycarbonate phone cases using an air spray gun. The coated phone case was UV-cured.

### Example 9

### Additional Antimicrobial Composition

A coating composition was prepared containing the following materials as follows:
1) Siloxane of bis-copolymer of Example 1
2) 2-hydroxyethylmethacrylate
3) 1,6-hexanediol diacrylate
4) Omnirad 184 photointiator (IGM)

These four components were admixed at a relative weight percent of 35:45:10:10. To that mixture, inorganic silver nanoparticles (silver (Ag) nanopowder/nanoparticles (Ag, 99.99%, 30-50 nm, w/˜0.2 wt % PVP Coated—available from U.S. Research Nanomaterials, Houston, Tex.) antimicrobial additive was added in an amount of 0.5 weight percent based on weight of the admixture. These materials were ultrasonicated for about 10 minutes. The composition is considered solvent free because individual components are miscible with each other without assistance of a further solvent.

The composition was air-sprayed onto a polycarbonate phone cases using an air spray gun. The coated phone case was UV-cured.

### Example 10

### Antimicrobial Testing

The coated phone cases produced in Examples 7 and 9 above were tested under the ISO 22196 which is a recognized method of evaluating the antibacterial activity of antibacterial-treated plastics, and other non-porous, surfaces of products.

Results of the ISO 22196 test are set forth in the following Table 2; which shows excellent results (97-99%) with differing test bacterium.

TABLE 2
Antimicrobial test results using ISO22196

| | | | Bacterial |
|---|---|---|---|
| Formulations | Test Method | Test bacterium | reduction |
| Example 7 | ISO 22196 | S. Aureus | 96.71% |
| | | E. Coli | 99.70% |
| Example 9 | | S. Aureus | 98.90% |
| | | E. Coli | 99.82% |

### EXAMPLES 11-14

### Colorant Compositions and Testing

### Example 11

### Colored (Silver) Composition

A coating composition was prepared containing the following materials as follows:
1) Siloxane of tri-copolymer of Example 1
2) 2-hydroxyethylmethacrylate
3) 1,6-hexanediol diacrylate
4) Omnirad 184 photointiator (IGM)

These four components were admixed at a relative weight percent of 40:50:5:5. To that mixture, inorganic silver nanoparticles (silver (Ag) nanopowder/nanoparticles (Ag, 99.99%, 30-50 nm, w/˜0.2 wt % PVP Coated—available from U.S. Research Nanomaterials, Houston, Tex.) antimicrobial additive was added in an amount of 0.5 weight percent based on weight of the admixture. These materials were ultrasonicated for about 10 minutes. The composition is considered solvent free because individual components are miscible with each other without assistance of a further solvent.

The composition was air-sprayed onto a silicon watch wrist band. The coated wrist band was UV-cured. No delamination or coating failure was observed over extended time with this composition that contained an inorganic colorant.

### Example 12

### Additional Colored (Red) Composition

A coating composition was prepared containing the following materials as follows:
1) Siloxane of tri-copolymer of Example 1
2) 2-hydroxyethylmethacrylate
3) 1,6-hexanediol diacrylate
4) Omnirad 184 photointiator (IGM)

These four components were admixed at a relative weight percent of 40:50:5:5. To that mixture, a commercially available organic red colorant was added in an amount of 50 weight percent based on weight of the admixture. These materials were ultrasonicated for about 10 minutes. The composition is considered solvent free because individual components are miscible with each other without assistance of a further solvent.

The composition was air-sprayed onto a nylon watch wrist band. The coated wrist band was UV-cured. A logo on the watch band was not peeled off or delaminated during extreme bending and twisting treatment.

### Example 13

### Additional Colored (Fluorescent) Composition

A coating composition was prepared containing the following materials as follows:
1) Siloxane of tri-copolymer of Example 1
2) 2-hydroxyethylmethacrylate
3) 1,6-hexanediol diacrylate
4) Omnirad 184 photointiator (IGM)

These four components were admixed at a relative weight percent of 40:50:5:5. To that mixture, a commercially available fluorescent dye was added in an amount of 5 weight percent based on weight of the admixture. These materials were ultrasonicated for about 10 minutes. The composition is considered solvent free because individual components are miscible with each other without assistance of a further solvent.

The composition was air-sprayed onto a nylon watch wrist band. The coated wrist band was UV-cured.

### Example 14

The fluorescent composition of Example 13 was sprayed onto a leather swatch. The spray-applied coating was conformal and evenly applied over the swatch surface. There was no significant difference noted between coated and uncoated areas of the swatch. Under UV illumination (365 nm), the coated swatch showed blue fluorescence whereas uncoated areas were not illuminated at 365 nm.

1. A coated substrate comprising:
a) a substrate;
b) a coating composition on the substrate, the coating composition comprising one or more organosilane polymers that:
1) are obtainable from one or more alkoxy-silane reagents; and
2) comprise a linear or branched chain structure; and
c) a topcoat composition associated with the coating composition.

2. The substrate of claim 1 wherein the one or more polymers have a weight average molecular weight of about 1000 or greater.

3. (canceled)

4. The substrate of claim 1 wherein the one or more polymers have a weight average molecular weight of about 4000 or greater.

5. (canceled)

6. The substrate of claim 1 wherein the one or more polymers are obtainable from a TEOS-type reagent.

7. (canceled)

8. The substrate of claim 1 wherein the one or more polymers comprise units of the following Formula (I): 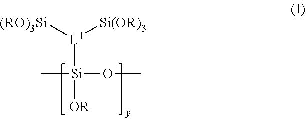
wherein in Formula (I): each R is the same or different and may be a hydrogen or non-hydrogen substituent; L¹ is a linker group; and y is a positive integer.

9. The substrate of claim 1 wherein the one or more polymers comprise units of the following Formula (IA): 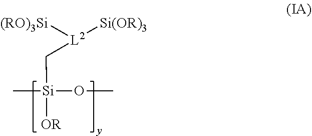
wherein in Formula (IA): each R is the same or different and may be a hydrogen or non-hydrogen substituent; L² is a linker group; and y is a positive integer.

10. The substrate of claim 1 through 9 wherein the one or more polymers comprise units of the following Formula (IB): 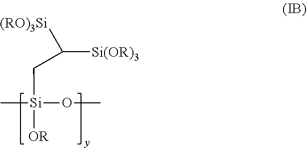
wherein in Formula (IB): each R is the same or different and may be a hydrogen or non-hydrogen substituent; and y is a positive integer.

11. The substrate of claim 1 wherein the one or more polymers comprise units of the following Formula (II): 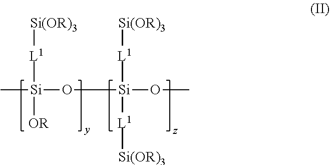
wherein in Formula (II): each R is the same or different and may be a hydrogen or non-hydrogen substituent; each L¹ is the same or different linker group; and y and z are the same or different and each is a positive integer.

12. The substrate of claim 1 wherein the one or more polymers comprise units of the following Formula (IIA): 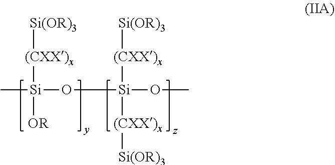
wherein in Formula (IIA): each R is the same or different and may be a hydrogen or non-hydrogen substituent; each X and X′ is the same or different and may be hydrogen or a non-hydrogen substituent; each x is the same or different positive integer; and y and z are each the same or different positive integer.

13. The substrate of claim 1 wherein the one or more polymers comprise units of the following Formula (IIB): 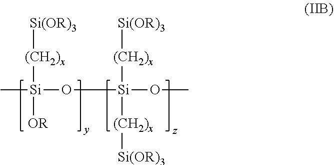
wherein in Formula (IIB): each R is the same or different and may be a hydrogen or non-hydrogen substituent; each x is the same or different positive integer; and y and z are each the same or different positive integer.

14. The substrate of claim 8 wherein each R is other than hydrogen.

15-17. (canceled)

18. The substrate of claim 1 wherein the reactive component comprises a hydroxyl acrylate compound.

19-21. (canceled)

22. A coated substrate comprising:
a) a substrate;
b) a coating composition on the substrate, the coating composition comprising one or more organosilane polymers; and
c) a topcoat composition associated with the coating composition,
wherein the one or more polymers comprise units of the following Formula (III), (IV) and/or (V): 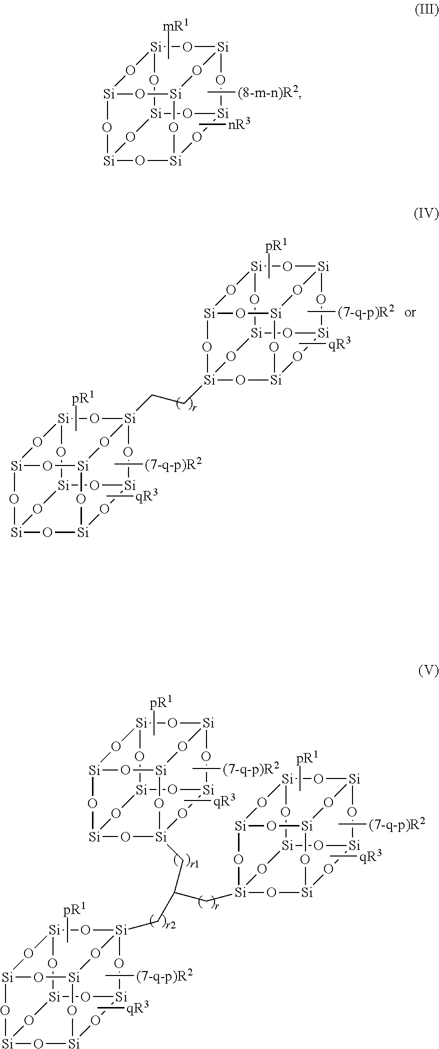
wherein in Formulae (III), (IV) and (V):
R¹ is a long chain alkyl or long chain fluorinated alkyl;
R² and R³ are each independently selected from the group consisting of C₁-C₁₅ alkyl, C₂-C₁₅ alkenyl, —NCO, —CH(O)CH₂, —NH₂, —NHC₁-C₆ alkyl, —OC(O)NHC₁-C₆ alkyl, —OC(O)NH₂, —P(O)(OC₁-C₆ alkyl)₂, —C₁-C₆ alkylSi(C₁-C₆ alkyl)₃, —C₁-C₆ alkylSi(C₁-C₆ alkyl)₂(OC₁-C₆ alkyl), —C₁-C₆ alkylSi(C₁-C₆ alkyl)(OC₁-C₆ alkyl)₂ —C₁-C₆ alkylSi(OC₁-C₆ alkyl)₃, —Si(C₁-C₆ alkyl)₂(OC₁-C₆ alkyl), —Si(C₁-C₆ alkyl)(OC₁-C₆ alkyl)₂ and —Si(OC₁-C₆ alkyl)₃, wherein one or more hydrogen atoms in C₁-C₁₅ alkyl or C₁-C₆ alkyl is independently optionally substituted with a —OC(O)C₁-C₄ alkenyl, —NCO, —(OC₁-C₄ alkyl)—CH(O)CH₂, —CH(O)CH₂, —NH₂, —NHC₁-C₄ alkyl, —OC(O)NHC₁-C₄ alkyl, —OC(O)NH₂, —P(O)(OC₁-C₄ alkyl)₂, —Si(C₁-C₄ alkyl)₂(OC₁-C₄ alkyl), —Si(C₁-C₄ alkyl)(OC₁-C₄ alkyl)₂ or —Si(OC₁-C₄ alkyl)₃;
m is an integer from 0 to 7;
n is an integer from 0 to 7;
p is an integer from 0 to 6;
q is an integer from 0 to 6;
r is an integer from 0 to 6;
r1 is an integer from 0 to 6;
r2 is an integer from 0 to 6;
wherein the sum of n and m is less than or equal to 7; and the sum of p and q is less than or equal to 6.

23-25. (canceled)

26. A method for providing a coated substrate, comprising:
a) applying a layer of a coating composition on the substrate, wherein the coating composition comprises one or more organosilane polymers that:
1) are obtainable from one or more alkoxy-silane reagents; and
2) comprise a linear or branched chain structure; and
b) applying a topcoat composition above the coating composition layer.

27-46. (canceled)

47. A method for providing a coated substrate, comprising:
a) applying a layer of a coating composition on the substrate, wherein the coating composition comprises one or more organosilane polymers; and
b) applying a topcoat composition above the coating composition layer, wherein the one or more polymers comprise units of the following Formula (III), (IV) and/or (V): 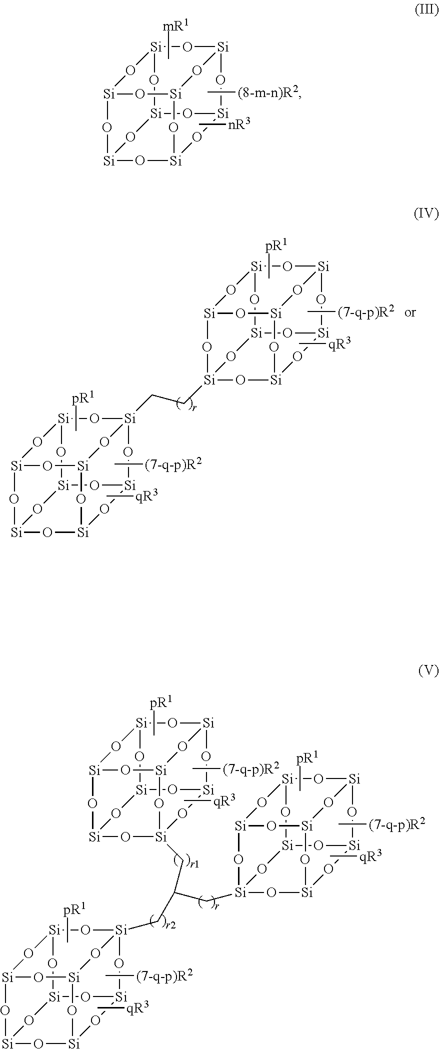
wherein in Formulae (III), (IV) or (V):
R¹ is a long chain alkyl or long chain fluorinated alkyl;
R² and R³ are each independently selected from the group consisting of C₁-C₁₅ alkyl, C₂-C₁₅ alkenyl, —NCO, —CH(O)CH₂, —NH₂, —NHC₁-C₆ alkyl, —OC(O)NHC₁-C₆ alkyl, —OC(O)NH₂, —P(O)(OC₁-C₆ alkyl)₂, —C₁-C₆ alkylSi(C₁-C₆ alkyl)₃, —C₁-C₆ alkylSi(C₁-C₆ alkyl)₂(OC₁-C₆ alkyl), —C₁-C₆ alkylSi(C₁-C₆ alkyl)(OC₁-C₆ alkyl)₂ —C₁-C₆ alkylSi(OC₁-C₆ alkyl)₃, —Si(C₁-C₆ alkyl)₂(OC₁-C₆ alkyl), —Si(C₁-C₆ alkyl)(OC₁-C₆ alkyl)₂ and —Si(OC₁-C₆ alkyl)₃, wherein one or more hydrogen atoms in C₁-C₁₅ alkyl or C₁-C₆ alkyl is independently optionally substituted with a —OC(O)C₁-C₄ alkenyl, —NCO, —(OC₁-C₄ alkyl)—CH(O)CH₂, —CH(O)CH₂, —NH₂, —NHC₁-C₄ alkyl, —OC(O)NHC₁-C₄ alkyl, —OC(O)NH₂, —P(O)(OC₁-C₄ alkyl)₂, —Si(C₁-C₄ alkyl)₂(OC₁-C₄ alkyl), —Si(C₁-C₄ alkyl)(OC₁-C₄ alkyl)₂ or —Si(OC₁-C₄ alkyl)₃;
m is an integer from 0 to 7;
n is an integer from 0 to 7;
p is an integer from 0 to 6;
q is an integer from 0 to 6;
r is an integer from 0 to 6;
r1 is an integer from 0 to 6;
r2 is an integer from 0 to 6;
wherein the sum of n and m is less than or equal to 7; and the sum of p and q is less than or equal to 6.

48. The method of claim 47 wherein R² is C₁-C₁₅ alkyl.

49. The method of claim wherein R² is C₁-C₁₅ alkyl substituted with —NCO or —CH₂CH₂CH₂NCO.

50. (canceled)

51. A coating composition, comprising one or more organosilane polymers that:
1) are obtainable from one or more alkoxy-silane reagents; and
2) have a weight average molecular weight of about 1000 or greater.

52. (canceled)

53. The composition of claim 5 wherein the one or more polymers are obtainable from a TEOS-type reagent.

54. The composition of claim 50 wherein the one or more polymers are obtainable from one or more bis(alkoxysilyl) and/or tris(alkoxysilyl) reagent.

55. The composition of claim 50 wherein the one or more polymers comprise units of the following Formula (I): 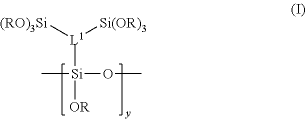
wherein in Formula (I): each R is the same or different and may be a hydrogen or non-hydrogen substituent; L¹ is a linker group; and y is a positive integer.

56-75. (canceled)
